(19) United States
(12) Patent Application Publication
(10) Pub. No.: US 2002/0007370 A1
(43) Pub. Date: Jan. 17, 2002

(54) Systems and methods for providing information services

(76) Inventor: Steven H. Brown, Rochester Hills, MI (US)

Correspondence Address: DICKINSON WRIGHT PLLC, Suite 800, 1901 L St., N.W., Washington, DC, 20036, US

(21) Appl. No.: 09/892,578

(22) Filed: Jun. 28, 2001

Related U.S. Application Data
(60) Provisional application No. 60/215,116, filed on Jun. 29, 2000.

(51) Int. Cl. G06F 17/00

(52) U.S. Cl. 707/501.1

(57) ABSTRACT

A method for providing information services includes reviewing sources of information to select relevant data, and further reviewing the data for placement for a website, entering the data selected for placement on the webpages, and arranging and displaying the entered data on at least the following sub-webs: industry overview, corporations in the industry, and products produced by the industry. Alternatively, the data may be arranged or displayed on at least the following sub-webs Siteguide, hot sheet and alliances. A computer system for providing information services includes an information service website that has at least one product sub-web, a corporate sub-web, and an industry overview sub-web.

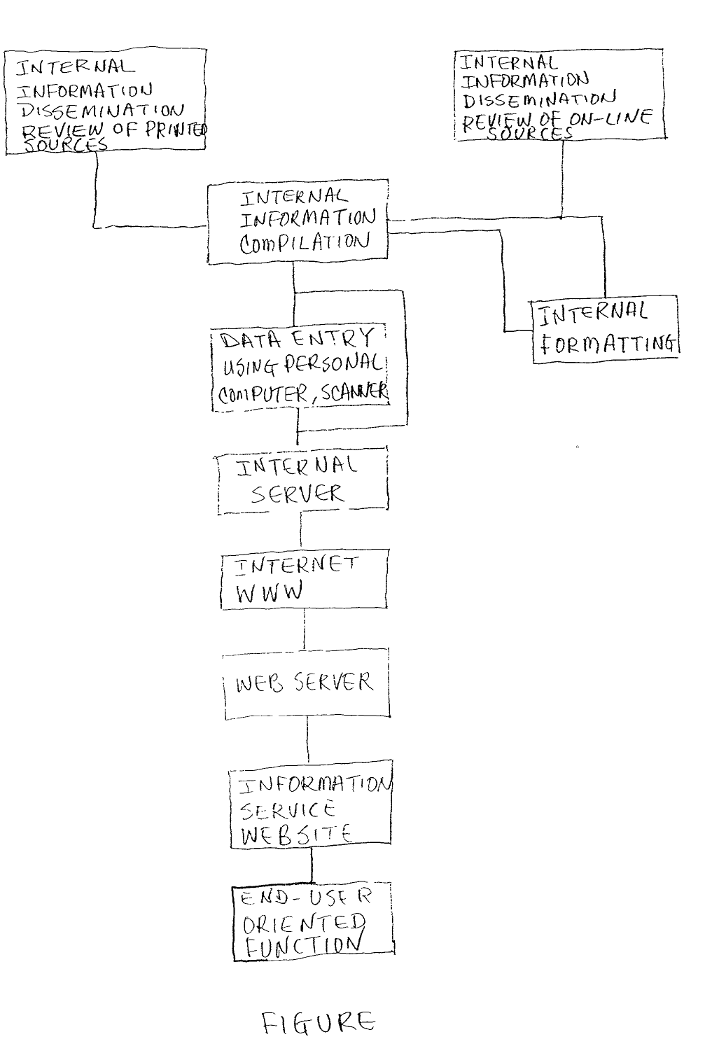

This application claims the benefit of U.S. provisional patent application 60/215,116, filed on Jun. 29, 2000, which provisional application is incorporated by reference in its entirety.

### FILED OF THE INVENTION

This invention relates to systems and methods for providing information services.

### BACKGROUND OF INVENTION

Professional in information services, such as marketing professional, everywhere have, since the beginning of their careers, struggled with gathering and digesting the massive quantities of pertinent information found in a wide variety of secondary literature sources. Typically, their mornings would begin very early with several major national newspapers, key trade journals and a few consumer magazines. Items of interest were usually flagged with a sticky note and handed off to an assistant for filing or cataloging. In most major corporations, entire departments were dedicated to “library services” or the function was simply housed in the “research” department.

Information retrieval took a major step forward with services such as Lexus/Nexus, computer search engines and even specialize “clipping services.” While these methods exponentially expanded the quantity of information and narrowed the focus of the searches, there still remained a huge problem in that the net result of all these methods was the same—articles, lots of them. They still remained unedited, unformatted, unanalyzed and had no competitive context associated with them.

Increased speed and accessibility failed to solve the basic challenges facing professional in information services, and may in fact have exacerbated it. Terms such as “information overload” crept into our vocabularies. Many companies talk about being “data rich and information poor.”

The other challenge encountered by professional in information services is the increasing number of proprietary information suppliers that offer goods and services. Managing literally hundreds of suppliers individually is a time-consuming, difficult and often confrontational situation. Adding to the tension is the competitive nature of these suppliers. Rarely in business do direct competitors exist harmoniously for the benefit of their clients.

As companies reduce the number of people dedicated to information services, time management becomes more critical than ever. Often, seasoned veterans and novices alike conduct informational research at all hours of the day or night, at their office, home or even from a laptop computer in a hotel room. Accessibility is a critical factor.

Of course, society as a whole was faced with this same situation. Yet, in the community of information services, where multi-million dollar decisions are based on timely competitive reconnaissance and trend analysis, information “paralysis” was simply unacceptable.

### SUMMARY OF THE INVENTION

As shown in the drawings and described in detail below, this invention provides systems and methods for information management which have a number of advantages over conventional systems and methods discussed above.

In accordance with one aspect of the invention, a method for providing information services includes reviewing sources of information to select relevant data, performed preferably by the staff, and further reviewing, preferably by one or more editors, the data reviewed and selected by the staff. At least a portion of the data reviewed by the editors is selected for placement on webpages. The method further includes entering the data selected for placement on the webpages, and arranging and displaying the entered data on at least the following sub-webs: industry overview, corporations in the industry, and products produced by the industry.

In accordance with another aspect of the invention, a method for providing information services includes reviewing sources of information to select relevant data, performed preferably by the staff, and further reviewing, preferably by one or more editors, of the data reviewed and selected by the staff. At least a portion of the data reviewed by the editors is selected for placement on webpages. The method further includes entering the data selected for placement on the webpages, and arranging and displaying the entered data in at least sections: Siteguide, Hot sheet and Alliances.

In accordance with a further aspect of the invention, a computer system for providing information services includes an information service website that has at least one product sub-web, a corporate sub-web, and an industry overview sub-web. The product sub-web includes at least one of the following super-categories: future product programs, issues by product-line, manufacturer's overview, media budgets, awards and recognition, positioning statements, marketing, vehicle targets, acknowledged competition, segment issues, sales trends, product info and photos, price ladder, lifecycle positioning, communication positioning, and growth/share matrix. The corporate sub-web includes at least one of the following super-categories: sales trends, e-commerce, financials, growth/share matrix, communication positioning, marketing programs, division list, and key issues. The industry overview sub-web includes at least one of the following super-categories: sales trends; growth/share matrix; marketing & advertising trends; media spending; demographics; aftermarket; design & technology; e-commerce; sales issues; safety; mergers, acquisitions and partnerships; environment; and general.

The present invention, based on feedback from its users, is “a new game, a new set of rules.” On the fronts of education and training, report/presentation development, and planning/competitive tracking, it establishes a new benchmark. It responds to the technology, in combination with social trend, that is changing the face of the entire communication process.

The present invention is unique in that users in marketing, advertising and manufacturing can reduce the time spent on researching, compiling, editing and formatting information and focus more on substantive issues, such as the development of sales proposals, with ever-increasing depth-of-knowledge of a given industry and/or manufacturer. The consumer can access the information efficiently and, based on the initially-acquired information, can determine what additional information should be obtained and where to obtain the additional information.

More importantly, the present invention provides an innovative approach to the collection, arrangement, presentation, and display of information, which allows for interactive interface between the information provider and consumer. In this way, the consumer, rather than the information provider, becomes the most powerful unit.

In the past, the information providers have commonly dominated the consumers, primarily because they always had more information and more money, allowing them to control the communications systems. The communications systems were set up so that the flow was always outbound, i.e. from the information provider to the consumer. Thus, the information provider controlled the content of the information, when it would be delivered and in what amounts.

The invention moves away from this conventional, one-way, out-bound communications system. One implication of this is that because consumers are more in control of information, they are therefore more “resistant to persuasion”, and as a result, selling. The key here is providing carefully crafted synergistic and credible information upon which the consumer can conclude that a particular option is better than another, based on their individual needs and wants.

In the area of marketing, for example, direct marketers traditionally have developed and delivered messages and information which favored them and not the buyer. They delivered their direct marketing programs when they wanted, when they found it convenient, and when they thought it might be profitable. It was when the sellers wanted to communicate, not when the buyers wanted to learn. With the present invention's systems and methods of selecting and presenting information, the buyer, not the seller will control the information flow. The buyer will access the information on demand so the seller will find him/herself in the situation of providing information continuously, rather than in bursts and campaigns which we use today.

### DETAILED DESCRIPTION OF THE PREFERRED EMBODIMENTS

The following description of the presently preferred embodiments of the invention refers to the accompanying drawings. The description is directed to and the drawings show exemplary embodiments of the invention, other embodiments are below without departing from the spirit and scope of the invention. The scope of the invention is defined by the appended claims. The description and drawings are merely illustrative, not limiting.

The following terms and acronyms are used throughout the detailed description:

Duplication of Materials no duplication of exact data from preceding 6-12 months.

AMIS—Automotive Information Services.

CMIS—Computer Information Services.

PHARMIS—Pharmaceutical Information Services.

Manufacturer—indicates the manufacturer of a given product in a given Information Service.

Super-Category—one of the over-arching main categories of data tracked in any or all of the Information Services.

Sub-Category—one of the more specific categories of data tracked under any or all of the Super-Categories of the Information Services.

Hot Sheet—a section that includes the latest industry news, and new sections added to or revisions to website.

Alliances—companies who may or may not subscribe to any or all of the Information Services but provide proprietary research data to the Information Services for distribution.

Subscriber Gateway—serves a dual-purpose of signaling to the subscriber that they are on the proper page on which to log-on to the service and shows current or potential subscribers the logos of those subscribers who want it to be known that they subscribe to the service.

Although it is applicable in any business or industry, the present invention is illustrated herein using the automotive industry as the primary example and the computer and pharmaceutical industries as secondary examples.

As illustrated in Figure, this preferred embodiment of the invention includes four main elements: internal information dissemination, internal information compilation function, internal formatting function, and end-user oriented function.

Internal Information Dissemination Function

The internal information dissemination function preferably includes a review of various sources of information, such as printed secondary literature (both consumer-oriented and trade journals) and online sources (both consumer-oriented and trade-related). Specifically, those sources of information may include, for example, edited textual extractions from newspapers, trade journals, websites, direct mail pieces, product catalogs, enthusiast magazines, and consumer magazines. Preferably, this review is conducted by the staff, although others, such as editors, may also participate.

The printed source review is one of the main elements of this invention. Hundreds of printed pages of data may be reviewed, preferably in each morning, for relevant marketing, advertising and sales-related data for a given category—the automotive industry is used here as the example.

This process may be carried out in any suitable manner. The following is an example of how the printed source review can be carried out as applied to the automotive industry.

1) Monday

a) Process key trade journals first.

b) Process Automotive News and Advertising Age first, as they contain the most relevant data for AMIS. (In the case of CMIS and PHARMIS, similar magazines in the computer and pharmaceutical industries may be reviewed.)

2) The rest of the week

a) Auto Trade/Enthusiast Magazines such as Car and Driver, Truck Trends, Automobile, etc. are reviewed for the following items:

b) Newspapers:

c) Consumer Magazines (GQ, Family Circle, McCall's, etc.)

3) Citations

a) Every article/ad must have proper sources listed somewhere on the document.

4) Where does it go?

a) All advertising goes to Graphics Coordinator for processing, scanning and reformatting.

b) Alternate power vehicle information, one copy of monthly sales charts from Automotive News, and a copy of weekly Consumer and Dealer Incentive charts from Automotive News go to Co-Editor.

c) Future product information and auto-related articles go to Editor.

d) One copy of monthly sales charts from Automotive News goes to Marketing Specialist.

e) Any new product catalogs are handled in the following manner:

i) The new catalog goes to Graphics Coordinator for cover scanning and placement.

ii) Catalog is then handed to Marketing Specialist for review for Positioning Statements and any other site-related data (AMIS content is placed on the appropriate pages by Marketing Specialist, when possible).

5) Filing

a) After articles and ads are processed and placed on the site, they are placed in bins for filing. Materials Processor sorts and files these items.

The online source review may run parallel with the printed source review, enabling the Editors to have immediate access to the latest information available—particularly in the cases of press releases, which ultimately generate the articles found in print the following business day. Alternatively, the online source review may precede or follow the printed source review. Many online sources (some of which are the online versions of the printed sources) are scanned each morning for articles and press releases related to the manufacturers covered by the Information Services.

The review of the online sources may be performed in any suitable manner. The following is an example of how the online source review may be performed, using AMIS as an example.

1. Compile a list of Internet/WWW Services.

2. Editor reviews the websites for automotive issues (computer issues in the case of CMIS or pharmaceutical issues in the case of PHARMIS) and prints them for editing.

3. For “Hot Sheet” materials uncovered from website review:

a. Each “Hot-Sheet” article should be printed, edited (refer Internal Information Compilation Function) and handed off to the staff.

b. Should Materials Processor find an article that appears to be a “Hot Sheet” item, it is given immediately to Editor for review and processing if necessary.

4. Upon Completion of website review, and prior to editorial review of any articles printed during the process, briefly review processed newspaper articles for “Hot Sheet” material not found during the website review.

5. All “Hot Sheet” items should be placed and immediately imported from the local web to the corresponding external webs in the following order:

a. Content page

b. Hot Sheet page

c. Repeat after each Hot Sheet item is added, so that there is the most current “Hot Sheet” material available to the users.

6. After all Hot Sheet items have been handed off, Editor should resume review of all remaining web, newspaper, and magazine articles.

7. Edited materials should be given to data entry staff.

Any articles needing special attention should be flagged with a post-it note with detailed additional instructions or with a request for entry person to see Editor.

8. All advertising should be given to Graphics Coordinator for review, scanning, placement and zipping.

Internal Information Compilation Function

All articles (from printed and online sources) are given to the Editor for thorough review, highlighting of key sentences, review of existing citations on website, determination of categorization and placement of articles (normal or “Hot Sheet” entry), notation of placement for data-entry, and distribution of articles for handling.

The following is an example of how the editorial review can be carried out, using AMIS as an example.

1. After a comprehensive and thorough review of all printed and website sources, all documentation (with the exception of printed advertising) is given to the Editor of a particular category, in this example:

Automotive.

a. Editor reviews all printed articles and website articles for duplication on two-tiers:

i. Review for the same article from printed source and online source, for example, clipped article from the print edition of a newspaper and electronic article printed in office.

1. This procedure is followed so that data entry can be reduced, as the text can be copied directly from the web source, while retaining the original printed source for the files.

2. In the event there is accompanying photography (i.e.: future product spy photos) in a black and white printed newspaper article, the color photo customarily accompanies the web source. The color photo is saved from the web source for processing and placement later, as newspaper photography is not the best representation of photography.

ii. Articles regarding the same subject, which are very similar in content but from separate sources.

1. On any given day, there may be five articles from five separate sources all based on a press release released the previous day. Each source may have a different inside source at the corporation about whom the article is written; therefore, the sources quoted and the information they add to the story may vary. In most cases, as part of the web source review, the original press release, on which these articles are based, has been received.

a. When available, the Corporate Press Release is reviewed first for corporate-level data.

b. All subsequent articles from that day are reviewed with the content of the Press Release and any previously reviewed articles from that day in mind.

b. Should there be no duplication of materials, each article is reviewed for relevant, new and/or updated information.

i. If the information in an article is deemed duplicate of citations already housed on the site, it is immediately processed for archive filing.

ii. If the information is new or updates previously listed citations, the article is processed in the following manner:

1. Text-Only Articles

a. The title, source, data and all new data is highlighted with a highlighting marker.

b. Should there be information in a long sentence and/or paragraph that duplicates existing content or is considered extraneous, an ellipsis is written at the end of the highlighted material to indicate where that section of relevant content ends. This process is repeated throughout the editorial review of that article.

c. After editorial review of the article is complete and the Editor is confident that all relevant material has been highlighted, the Editor writes the desired location in which the content is to be placed by data entry personnel.

d. In the common event that there is information that is relevant to more than one manufacturer, segment, category, etc. copies of the article are made and the article is reviewed again using the same process as above for content respective of these other areas of consideration.

2. Text with Accompanying Photography

a. When photography accompanies an article the Editor (using the same methodology as Text-Only articles) must determine whether or not the photography is relevant or duplicate.

b. Should photography be new or updated (examples of which would be new vehicle photography or future product spy photography) the Editor writes “scan” next to the photo and (when cited in the article) highlights the photographers name and company (this ensures the proper party is credited with the photography). The photograph will be scanned by data entry personnel and added to the page on which the related text is housed on the site.

Internal Formatting Function

After the editorial review is complete, all materials are passed along to support staff for processing, re-formatting and/or data entry (depending upon the materials). In a preferred embodiment, there may be four types of data passed along to support staff:

Text-based articles

Sales and product lifecycle data statistics

Photography (both current photography and “spy” photos)

Advertising

All data may receive the same level of processing priority; however, due to the nature and timing of the statistical analysis and the resulting PowerPoint 97 slide shows when data is made available (usually the first of the month) this type is given a higher priority.

Using AMIS as an example, the following illustrates how this process can be carried out to get the data on the appropriate webpages.

a) The Editor preferably has printed along the side or on the bottom of the article where the item should be placed.

b) The data should be formatted for placement on a webpage, and citation should be provided with each article.

c) Should a sub-heading listed by the Editor not appear on the page (indicating a new sub-category), a new sub-category page is created to house the new data and any subsequent data regarding that topic. A hypertext link may be added so that users are aware of this new option.

End-User Oriented Function

This aspect of the invention provides an innovative approach to the arrangement, presentation, and display of information, which allows for interactive interface between the information provider and consumer. The consumer can access the information efficiently and, based on the initially-acquired information, can determine what additional information should be obtained and where to obtain the information. In this way, the consumer, rather than the information provider, becomes the most powerful unit and can acquire the necessary information to determine that a particular option is better than another, based on their individual needs and wants.

In this section, AMIS is used as an example to illustrate the End-User Oriented Function, although this method may be used in connection with any other industry with some of the same or similar categories of information.

To use AMIS, users enter the web address into their browser software and are taken to the website. Registered members of AMIS click on the area of the image-map labeled “AMIS Members,” which is linked to the “AMIS Subscriber Gateway.” When applicable, users click on their respective companies logo/icon (which is linked, in most cases, directly to the AMIS Index Page). Upon clicking the icon, users are prompted for their Username and Password, which has previously been assigned to their company. Once the Username and Password are validated, the AMIS homepage loads in the browser window.

The AMIS homepage includes a frame page which houses three separate pages—“Siteguide,” “Hot Sheet,” and “AMIS Alliances.” The Siteguide leads to several sub-webs relating to product, corporate and industry information, which may include the following:

Cars—houses all data specific to those manufacturers who currently or will sell passenger cars (as defined by prevailing industry standards) in the United States (or any other country or a group of countries) in the previous 18 month or forthcoming five year periods. Although this first product sub-web is directed to “Cars” in this preferred embodiment, it may be directed to any other product in the automotive industry (or any product in the computer industry in the case of CMIS, for example).

Trucks—houses all data specific to those manufacturers who currently or will sell light trucks (as defined by prevailing industry standards) in the United States (or any other country or a group of countries) in the previous 18 month or forthcoming five year periods. Although this second product sub-web in this preferred embodiment is directed to “Trucks,” it may be directed to any other product in the automotive industry (or any product in the computer industry in the case of CMIS, for example).

Corporate—houses all data specific to those corporations who are owners (which may be defined as 80%-100% shareholders, for example) of multiple manufacturers of passenger cars and/or trucks which are currently considered under prevailing industry standards to be “divisions” of a larger whole corporation. Data may be tracked in (but not limited to—as changes in the industry or user needs dictate) eight super-categories Sales Trends, E-Commerce, Financials, Key Issues, Growth/Share Matrix, Communication Positioning, Marketing Programs, and Division List (see “Super-Category” definitions). Each super-category may include one or more sub-categories where applicable.

Industry Overview—houses all data specific to the “industry” in general that either is not manufacturer specific or refers to the industry with more than one or two manufacturers in the data for a period of 18 months. Data is tracked in (but not limited to—as changes in the industry or user needs dictate) in twelve super-categories: Sales Trends; Growth/Share Matrix; Marketing & Advertising Trends; Media Spending; Demographics; Aftermarket, Design & Technology; E-Commerce; Sales Issues; Safety; Mergers, Acquisitions and Partnerships; Environment; and General. Each super-category may include one or more sub-categories where applicable (see “Super-Category” definitions).

In this embodiment of the invention, each product sub-web, such as Cars or Trucks, may include (1) a list of manufacturers, (2) a product segment index, and (3) a list of super-categories containing information about each manufacturer.

In each product sub-web, data on each manufacturer may be tracked in (but not limited to—as changes in the industry or user needs dictate) fourteen super-categories: Manufacturer's Overview, Sales Trends, Product Info & Photos, Growth/Share Matrix, Acknowledged Competition, Issues by Carline, Vehicle Targets, Media Budgets, Positioning Statements, Future Product Programs, Price Ladders, Lifecycle Positioning, Communication Positioning, Awards and Recognition, and Marketing Programs (see “Super-Category” definitions).

Each super-category about a manufacturer may be accessed by selecting the manufacturer name from the list of manufacturers displayed on the product sub-web. Doing so will display a list of the super-categories concerning the manufacturer. Then, from the list of super-categories, select the super-category of interest. Alternatively, the super-category about the manufacturer may be accessed by selecting from the list of super-categories displayed on the product sub-web, which will bring up a list of manufacturers. Then select the name of the manufacturer.

Each super-category may include one or more sub-categories. For example, in a preferred embodiment, the super-category, Manufacturers Overview, may include from two to approximately 25 hypertext-linked sub-categories. Likewise, there may be anywhere from two to approximately 25 hypertext-linked sub-categories on the Marketing Programs pages. Examples of sub-categories under each super-category are provided in Appendix I.

Within each sub-category, there may be articles and/or photographs relating to the sub-category. Clicking on any of these hypertext-linked sub-categories will either drop to the “book-marked” sub-category on that particular page or load a separate page dedicated to that sub-category depending upon the volume of information found under that sub-category. Single high-volume, text-oriented category pages may split sub-categories into separately tracked pages in an effort to reduce the time spent downloading the originating super-category pages. The same is true for any text-heavy pages located under all sub-webs.

The product segment index provides a list of product segments included in the subject product. In Cars sub-web, for example, the product segment index lists the following car segments: Economy, Small, Lower Middle, Midsize, Mid-Specialty, Upper Middle, Traditional Full-size, Alternative Power, Small Sporty, Mid-Sporty, Specialty Sports, Entry Luxury, Traditional Luxury, Prestige Luxury, and Specialty Luxury. Each car segment may include the following categories of information: Sales Trends, Product Info & Photos, Growth Share Matrix, Price Ladders, Future Product Programs, Life Cycle Positioning, and Segment Issues.

Depending upon the current information-sharing alliances in place, there may be links built into the context of the Super-Category pages that refer users to either an external website/page of an Alliance Partner or to AMIS Exclusive Satellite Websites.

Super-Category Definitions

Manufacturer's Overview. The goal is to provide the user with a recap of the key issues affecting a manufacturer over the past few years. This information is broken up into sections such as business planning issues, customer service issues, strategic planning issues, distribution issues, plant and production issues, acquisitions, mergers, retail operation issues, strategic partnerships and alliances. (See Sub-Categories in Appendix I)

Sales Trends. Sales figures used on the AMIS site are extracted from Automotive News on a monthly and yearly basis. These represent total U.S. sales and include both retail and fleet units. The Calendar Year End sales are always reflected so as not to be confused with Model Year statistics. The most recent numbers may be reflected as Seasonally Adjusted Annual Rate. This means that annual sales have been projected based on creating a monthly average of sales to date and multiplying by 12 months in the year.

Product Info & Photos. The Product Info & Photos roster is derived from manufacturer's catalogs and consumer websites. Throughout a particular model year, changes can occur, as the manufacture adds and deletes products and makes changes to products. Next to each product name is a hyperlink to the product segment in which the product has been placed. The Product Info & Photos section also contains photographs of current model-year vehicles. Photos in this section were either scanned from product catalogs or copied from manufacturer's websites. These photos are provided for visual and research reference only and not for commercial reproduction. They can be used in presentations but not for any purposes that violate copyright restrictions.

Model years traditionally have begun October 1. However, recently manufacturers have introduced model year products earlier in the year. When this happens, both the most recent product photo and the model year product photo that traditionally belong in that calendar year are listed. The most recent product photo will be at the bottom of the product photo chart. Product Information and Photos are also tracked by product segments.

Acknowledged Competition. This super-category comes directly from the manufacturer's consumer site and/or from public relations material. Once in a great while, another source will be used and, when this happens, it is properly cited. This information is offered as an indication of what the manufacturer suggests or targets as competition for specific products, not what outsiders consider competition.

Issues by Car/Truck/Product Line. This super-category contains information about particular vehicles. This information may be about issues specific to the vehicle, problems, or any other relevant information about a particular vehicle that does not clearly fit in any other category. The information in Issues by Product Line can sometimes be found in other sections on the AMIS site.

Vehicle/Product Targets. This section describes vehicle targets, both demographic and psychographic, as acknowledged by the manufacturer.

Media Budgets. The Media Budgets section contains published figures for media budgets. This section frequently sites information from Competitive Media Reporting as reported in newspapers and magazines.

Positioning Statements. In this super-category are messages and statements that indicate potential marketing and strategy direction. The goal is to identify as much insight as possible into the mindset of the manufacturer in an effort to add a level of projectability on its actions. This data is usually extracted from manufacturer consumer-oriented catalogs.

Future Product Programs. This super-category tracks a wide variety of trade publications to closely monitor changes, additions and deletions to future product programs. By understanding the dynamics of product programs, especially given the lead-time involved in developing a new product, one can project potential marketing needs over a substantial horizon. This projectability forms the foundation for being more proactive in business. This information is also tracked by product segment.

Price Ladders. Price ladder analysis is commonly done in research and marketing departments across the country. The goal of including these charts on the AMIS website is to provide one of many tools in evaluating a competitor's strategy. For this reason, only base M.S.R.P. figures published at the beginning of the model year is used and is updated only when new products are added. Therefore, regardless of how often a manufacturer changes the vehicle prices throughout the year, in the case of AMIS—pricing is not updated from the original launch pricing. This allows for strategic positioning consistency from year to year. This information is also tracked by product segment

Lifecycle Positioning. Product lifecycle charts offered on the AMIS website are visual interpretations of future product activity from the perspective of the website provider. The format and labels are chosen to more closely reflect the utility of the end user of the service. The goal is to provide as accurate a characterization of the business at any one given point in time as possible.

The first year of a launch/redesign is placed in the “innovator” section. Year two is in the “early adopter” phase. Years three and four are positioned in the “mature” section. Year five resides in the “late adopter” area . . . and so on. By applying this approach consistently across all vehicle and segment lines, an interesting look at the business situation of the future is obtained.

Communication Positioning. This section identifies the language a manufacturer uses to portray its products and image in advertising, which is useful when building proposals for these manufacturers. Advertising is tracked from national newspapers and a broad spectrum of consumer-based magazines in an attempt to better understand the mindset of the company.

Segment Issues. This super-category includes articles that concern issues for a product segment as a whole. The goal is to cover information that provides insight into past, current or future direction for a market segment.

Awards & Recognition. This section tracks the ever-growing area of product awards. Awards tell a story about product and image attention in the community. Therefore, they are provided as published in the literature to demonstrate who is garnering attention and who is not.

Marketing Programs. With integrated marketing becoming increasingly important, information that provides insight into the “below-the-line” initiatives of the various manufacturers becomes more important. This knowledge is useful for building program proposals because it provides an idea of the programs the manufacturers are willing to support. Additionally, it subtly suggests targeting, regionality, etc.

The marketing programs pages are divided up into individual pages by sub-categories (see Appendix I). Articles are placed on the page according to what their main focus is. For example, an article on Buick's participation in the WNBA could, conceivably, be placed under any of the following headings: Event Marketing, Women's Marketing, Promotions, or Sports Sponsorships.

Seasonality. Seasonality is an investigation of monthly product or segment sales trends over time. The information gathered is most often used to properly time the launch of advertising or promotional initiatives. Industry analysts suggest that seasonal “peaks and valleys” occur as a function of new product launches, the demographic profile of the buyer, application of the product to weather patterns, manufacturer incentive programs, availability of disposable income for consumers, etc. Many would argue that seasonality can be artificially manipulated by the manufacturer through promotional practices. Still, consistency over several years often reflects a deeper root cause. This information is also tracked by product segment.

Consumer Incentive Programs. Although incentive programs for retail consumers are frequently tracked, data in this super-category are directed to the relationship between incentives and sales or the relationship among media spending, incentives and sales.

In attempting to sift through the information and develop charts, it was realized that there is a need for some “rules” in recording, reporting, and presenting the various programs:

Partial month programs are always shown as the full month. This is true even if the program only ran one week of the month, so that at least some program was in place for that particular month.

In general, only current model year products are shown.

Except for the 4th quarter of the calendar year, incentives on last year's grounded vehicles are not posted.

October through December of the calendar year contain incentives for the previous and current model year products. This is reflective of “close-out” programs and launch initiatives. For example, during October of 1996, both 1996 and 1997 incentive programs are shown.

In all cases, the lowest cash rebate listed, when offers differ by model within a vehicle line is shown. The reason is that “at least” data are shown to avoid the possibility of over-inflating the figures.

The lowest finance percentage rate is also shown when a “range” or options exist. The reason is that the most often selected rate will be the lowest one and will represent the bulk of purchases.

While “cash back” and “finance rate” are both shown on the same chart, in most cases the consumer has an “either/or” decision to make. In some rare cases, they are both offered at the same time.

Dealer Incentive Programs. The Dealer Incentive section has been included to provide insights into rebates offered from the manufacturer to the dealer on specific vehicles within its portfolio. As opposed to Consumer Incentives, where the rebate is offered directly to the consumer, here the incentive is provided to the dealer in an effort to stimulate a more aggressive sales push. One advantage to Dealer Incentives (vs. their Consumer counterparts), is that they are invisible to the buying public, thereby protecting the product's brand image. The thinking is that promotional efforts will not diminish the reputation of the vehicle by suggesting a “clearance sale” tonality. Additionally, this logic plays on the business realities of the dealer to move the product to earn the rebate.

Dealer Incentives on the AMIS website are offered as a means of rounding out the perspective of seasonal sales. The marketing philosophies of various manufacturers dictate their usage of either Dealer or Consumer Incentives, or both. By studying their application by manufacturer, gain greater insights into the strategic thinking of the company are gained.

The methodology for chart construction is virtually identical to that of the Consumer Incentives.

Growth-Share Matrix (GSM). This super-category offers insight into the client's portfolio management “challenges and opportunities.” It has been developed to provide the user with statistically significant differences in products (brand) that can be consistently applied across all competitors in the industry. These matrixes have been built on a Corporate, Division and Segment basis. These various “looks” at coordinate based placements aid in the hypothesis generation process with regards to priorities placed on products, potential marketing/advertising budgets based on their relative importance, strategic direction, and other key marketing questions. The goal is to allow AMIS users the chance to see the bigger picture and perhaps even anticipate future marketing direction.

The GSM is an analytical tool designed to offer a statistical perspective on a company's product portfolio “challenges and opportunities” from a macro point-of-view. The thinking is that by understanding how all the products are performing relative to each other, the directional decisions can be made based on prioritizing them on the measures of “share” (of industry, division or segment) and “growth” (or decline in units compared to the year previous).

The GSM is comprised of several parts: “x” and “y” axes, and the resulting four distinct quadrants that emerge naturally. The “x axis” is a measurement of “share of industry, division or segment” in reverse order. The “y axis” is a measure of “growth” (or decline) verses year-ago. All coordinate points are offered on an “index” basis to make them relevant to each other. The charts are constructed so that they intersect at 100 (or the statistical norm). The reason for this is that it is very easy to identify products that are performing above or below norm.

There are four quadrants that naturally emerge from the arrangement of axes as described above. These are as follows: high share, high growth (“northwest” quadrant) which we refer to as “stars,” high share, low growth (“southwest” quadrant), low share, high growth (“northeast” quadrant), and low share, low growth (“southeast quadrant).

The key purpose of the GSM is to better understand the relative importance of a particular product to a Corporation, Division or segment in relation to others in the portfolio. The GSM allows for the accurate determination of “how” important based on statistical coordinates and spatial distance between/among them.

The GSM is an important analytical tool for several reasons. First, it allows for the determination of “just how important” is a particular product to a manufacturer in meaningful statistical terms. Second, it provides the directional support for potential advertising and marketing support base on ranked priority. Third, it offers a tracking service to identify changes in priority or position over time. Fourth, it identifies products that may need significant changes to succeed or warrant being dropped completely. Finally, it graphically illustrates the strategic situation facing the manufacturer.

Downloadables

There is an extensive collection of “downloadable” tools available for users of any or all of the website. In the preferred embodiment, for example, there are generally four types of downloadables:

1. Photography provided in two sizes: a “thumbnail” and original size for presentations.

Current Product Photography

Future Product or “spy” photos (particularly in Automotive)

2. Print Advertisements—provided in two sizes: a “thumbnail” and original size for presentations.

3. PowerPoint Presentations—completely editable by end-user, including any linked spreadsheets/graphs.

4. Compressed zip files—there are two types of zip files provided for easy downloads of groups of photography or faster downloads of larger PowerPoint 97 slide shows

Compilation zips—photography, print ads, source text files

Presentations zips—single PowerPoint 97 presentations

### Appendix I

Super Categories

Cars and Trucks

Future Product programs

Issues by Carline/Truckline

Manufacturer's Overview

Media Budgets

Awards and Recognition

Positioning Statements

Marketing Programs

Vehicle Targets

Acknowledged Competition

Segment Issues

Sales Trends

Product Info and Photos

Price Ladder

Lifecycle Positioning

Communication Positioning

Growth/Share Matrix

Corporate

Sales Trends

E-Commerce

Financials

Growth/Share Matrix

Communication Positioning

Marketing Programs

Division List

Key Issues

Industry Overview

Sales Trends

Marketing & Advertising Trends

Media Spending

Demographics

Aftermarket, Design & Technology

Growth/Share Matrix

E-Commerce

Sales Issues

Safety

Environment

Mergers, Acquisitions & Partnerships

General

Sub-Categories

Corporate Level—Marketing Programs

Auto/Trade Shows

Certified Used Marketing

Co-Branding

Corporate/Global Ad(vertising) Campaigns

Credit Cards

Database/Direct Marketing

Diversity Programs

Event Sponsorships

Insurance

Interactive/Internet

Magazine Sponsorships

Marketing Aimed at Women

Marketing Aimed at Youth Mobility Programs

Minority Marketing

Motorsports

Movie Tie-Ins

Museum

Non-Profit Sponsorships

Outdoor/Terminals

Radio

Regional Marketing

Safety Programs

Sports Sponsorships

TV Sponsorships

Yellow Pages

Corporate Level—Key Issues

Agency/Media Issues

Business Planning

Dealer Issues

History/Overview

Mergers, Acquisitions & Partnerships

Financing/Leasing

Other Products, Parts and Accessories

Brand Issues

Environment

International Issues

Awards

Corporate Level—Financials

Legal Settlements

Net Profit

Net Loss

Market Share

Stocks

Industry Overview—Marketing & Advertising Trends

Broadcast

Consumer Data Privacy

Direct Marketing

General

Interactive/Internet

Outdoor/Terminals

Print

Industry Overview—Demographics

General

African-American

Asian

Boomers

European

General Consumer Buying

Gen X

Gen Y/Echo Boomers

Grey Market

Hispanic

Latin American

Gay/Lesbian Marketing

Industry Overview—E-Commerce

General

B2B (Business to Business)

Internet Taxes

Privacy/Security

Industry Overview—Sales Issues

General

Domestic

Exports

Imports

Incentives

Industry Overview—Safety

General

Ratings

NHTSA

OSHA

Airbags

Child Seats

Seat Belts

Trunk Latches

Industry Overview—Environment

EPA

Fuel Economy

Air Pollution

Emissions

General

Industry Overview—General

Dealer Issues

General

Globalization

Legal

Car & Truck Companies—Marketing Programs

Auto/Trade Shows

Brand Publications

Catalog Covers

Certified Pre-owned

Contests/Sweepstakes

Dealer/Delivery Programs

Direct Mail/Database

Event Sponsorship

Minority Marketing

Interactive/Internet

Introduction

Magazine Sponsorships

Marketing Aimed at Women

Motorsports

Movie Tie-Ins

Non-Profit Sponsorships

Outdoor/Terminal

Owner's Programs

Co-Branding

Regional Marketing

Safety Programs

Sports Sponsorships

TV Sponsorship

Car & Truck Companies—Manufacturer's Overview

Agency/Media Issues

Alliances

Business Planning

Image

Regional

Strategic Planning

Retail Operations

Mergers, Acquisitions & Partnerships

Customer Service

Dealer Issues

Plant/Production/Labor

Financing/Leasing

International

Distribution

History

E-Commerce

Management

Environment

### Appendix II

Presently, implementation of the preferred embodiment of the present invention may require one or more of the following internal tools, although other internal tools, which perform the same or similar functions, may be used.

1) Microsoft FrontPage 98+, Excel, PowerPoint 97.

2) WinZip or Pkzip.

3) Microsoft Internet Explorer 4.0+ and/or Netscape Navigator 4.0+.

4) Internal server(s) and individual workstations on a network with FrontPage 98 and its required server extensions and additional support software installed.

5) A dedicated Internet/WWW connection.

6) Flat bed scanner(s) and graphics software (such as Adobe Photoshop 5.0)

7) A continuously updated, substantial library of current industry-related secondary literature (See “Sources”).

8) Editorial personnel and support staff trained in basic marketing principles and software packages.

9) Internet/WWW Server housing the end-user product(s) with a static IP address, running FrontPage 98+ extensions.

10) Internet/WWW usage statistics tracking software both running internally and externally.

11) Comprehensive categorization and sub-categorization of all marketing and/or business-related aspects of targeted industries. (See “Super-Categories” and “Sub-Categories)

12) Comprehensive methodologies for the development and maintenance of statistical tracking and representation in Excel spreadsheets and corresponding PowerPoint 97 Presentations. (See forthcoming “Presentation Methodologies” Section)

End-users may need one or more of the following external tools to use the preferred embodiment of the present invention, although end-users may use other external tools which perform the same or similar functions.

13) Personal/business computer.

14) Internet/WWW access and compatible browser software (Internet Explorer 4.0+ or Netscape Navigator 4.0+.

15) A basic understanding of marketing, strategic planning and situational analysis principles and an expressed need for tools to assist in the application of these principles

16) User ID and Password provided by Primary Contact at subscribing Company.

17) Either Microsoft PowerPoint 97 or Microsoft PowerPoint 97 Viewer installed on computer used to edit/access slide shows.

1. A method for providing information services comprising:
(1) reviewing sources of information to select relevant data;
(2) further reviewing the data selected in step (1) by an editor, and selecting at least a portion of the data selected in the step (1) for placement on webpages;
(3) entering the portion of the data selected in step (2) for placement on the webpages; and
(4) arranging and displaying the data entered in step (3) on at least the following sub-webs: industry overview, corporations in the industry, and products produced by the industry.

2. The method of claim 2, wherein step (1) includes reviewing printed and on-line sources of information.

3. The method of claim 2 further including reviewing the on-line sources of information for data to be placed on a hot sheet webpage.

4. The method of claim 3, wherein step (2) includes reviewing of the data selected in step (1) from the printed sources of information for data to be placed on the hot sheet webpage.

5. The method of claim 4, wherein after having reviewed the printed and online sources of information for the data to be placed on the hot sheet webpage, review the printed and online sources of information for data to be placed on other webpages.

6. The method of claim 2, wherein reviewing printed sources of information includes: (a) reviewing trade journals for future product photography, customer and dealer incentives charts, sales charts, general materials, and client-specific materials; (b) reviewing newspapers for advertising materials and general information; and (c) reviewing consumer magazines for advertising materials and general information.

7. The method of claim 1, wherein step (1) includes providing citations for the selected data.

8. The method of claim 1, wherein step (1) includes reviewing the sources of information for marketing, advertising, sales-related and client-specific data.

9. The method of claim 1, wherein step (2) includes reviewing the data selected in step (1) to determine duplication, to highlight important information, and to determine the data's categories and placement on the webpages.

10. The method of claim 1, wherein the portion of the data selected in step (2) includes text-based articles, sales and product lifecycle date statistics, photography and advertising, and wherein entering the portion of the data selected in step (2) into the webpages includes first entering the sales and product lifecycle date statistics.

11. The method of claim 1, wherein the sub-web of industry overview includes data specific to the industry in general.

12. The method of claim 11, wherein the sub-web of industry overview includes at least one super-category.

13. The method of claim 12, wherein the at least one super-category includes at least one of the following super-categories: sales trends; growth/share matrix; marketing & advertising trends; media spending; demographics; aftermarket; design & technology; e-commerce; sales issues; safety; mergers, acquisitions and partnerships; environment; and general.

14. The method of claim 13, wherein at least one of the super-categories includes at least one sub-category.

15. The method of claim 14, wherein the super-category of marketing & advertising trends includes at least one of the following sub-categories: broadcast, consumer data privacy, direct marketing, general, interactive/internet, outdoor/terminals, and print.

16. The method of claim 14, wherein the super-category of demographics includes at least one of the following sub-categories: general, African-American, Asian, boomers, European, general consumer buying, Generation X, Generation Y/echo boomers, grey market, Hispanic, Latin American, and gay/lesbian marketing.

17. The method of claim 14, wherein the super-category of e-commerce includes at least one of the following sub-categories: general, business to business, Internet taxes, and privacy/security.

18. The method of claim 14, wherein the super-category of sales issues includes at least one of the following sub-categories: general, domestic, exports, imports, and incentives.

19. The method of claim 14, wherein the super-category of safety includes at least one of the following sub-categories: general, ratings, NHTSA, OSHA, airbags, child seats, seat belts, and trunk latches.

20. The method of claim 14, wherein the super-category of environment includes at least one of the following sub-categories: EPA, fuel economy, air pollution, emissions, and general.

21. The method of claim 14, wherein the super-category of general includes at least one of the following sub-categories: dealer issues, general, globalization, and legal.

22. The method of claim 1, wherein the sub-web of corporations in the industry includes at least one super-category.

23. The method of claim 22, wherein the at least one super-category includes at least one of the following super-categories: sales trends, e-commerce, financials, growth/share matrix, communication positioning, marketing programs, division list, and key issues.

24. The method of claim 23, wherein at least one of the super-categories includes at least one sub-category.

25. The method of claim 24, wherein the super-category of marketing programs includes at least one of the following sub-categories: auto/trade shows, certified used marketing, co-branding, corporate/global advertising campaigns, credit cards, database/direct marketing, diversity programs, event sponsorships, insurance, interactive/internet, magazine sponsorships, marketing aimed at women, marketing aimed at youth, mobility programs, minority marketing, motorsports, movie tie-ins, museum, non-profit sponsorships, outdoor/terminals, radio, regional marketing, safety programs, sports sponsorships, TV sponsorships, and yellow pages.

26. The method of claim 24, wherein the super-category of key issues includes at least one of the following sub-categories: agency/media issues; business planning; dealer issues; history/overview; mergers, acquisitions & partnerships; financing/leasing; other products; parts and accessories; brand issues; environment; international issues; and awards.

27. The method of claim 24, wherein the super-category of general includes at least one of the following sub-categories: legal settlements, net profit, net loss, market share, and stocks.

28. The method of claim 1, wherein the sub-web of each product produced by the industry includes at least one of the following: corporations making the product, product segment index, and product information.

29. The method of claim 28, wherein the product segment index includes a list of product types.

30. The method of claim 28, wherein the product information includes at least one of the following super-categories: future product programs, issues by product-line, manufacturer's overview, media budgets, awards and recognition, positioning statements, marketing, vehicle targets, acknowledged competition, segment issues, sales trends, product info and photos, price ladder, lifecycle positioning, communication positioning, and growth/share matrix.

31. The method of claim 30, wherein the each super-category includes at least one sub-category.

32. The method of claim 31, wherein the super-category of marketing programs includes at least one of the following sub-categories: product/trade shows, brand publications, catalog covers, certified pre-owned, contests/sweepstakes, dealer/delivery programs, direct mail/database, event sponsorship, minority marketing, interactive/internet, introduction, magazine sponsorships, marketing aimed at women, motorsports, movie tie-ins, non-profit sponsorships, outdoor/terminal, owner's programs, co-branding, regional marketing, safety programs, sports sponsorships, and TV sponsorship.

33. The method of claim 31, wherein the super-category of manufacturer's overview includes at least one of the following sub-categories: agency/media issues; alliances; business planning; image; regional; strategic planning; retail operations; mergers, acquisitions & partnerships; customer service; dealer issues; plant/production/labor; financing/leasing; international; distribution; history; e-commerce; management; and environment.

34. The method of claim 1 further including providing a downloadable sub-web for at least one of the following sub-webs: industry overview, corporations in the industry, and products produced by the industry.

35. A method for providing information services comprising:
(1) reviewing sources of information to select relevant data;
(2) reviewing the data selected in step (1), and selecting at least a portion of the data selected in the step (1) for entry into webpages;
(3) entering the portion of the data selected in step (2) into the webpages; and
(4) arranging and displaying the data entered in step (3) in at least sections: Siteguide, Hot sheet and Alliances

36. The method of claim 35, wherein the Siteguide section includes at least the following sub-webs: industry overview, corporations in the industry, and products produced by the industry.

37. The method of claim 35, wherein the hot sheet section includes the latest industry marketing-related news, and new sections of or revisions to the website.

38. The method of claim 35, wherein the alliance section includes information made available by companies which provide proprietary research data to website for distribution.

39. A computer system for providing information services comprising an information service website having
at least one product sub-web, the product sub-web including at least one of the following super-categories: future product programs, issues by product-line, manufacturer's overview, media budgets, awards and recognition, positioning statements, marketing, vehicle targets, acknowledged competition, segment issues, sales trends, product info and photos, price ladder, lifecycle positioning, communication positioning, and growth/share matrix;
a corporate sub-web, the corporate sub-web including at least one of the following super-categories: sales trends, e-commerce, financials, growth/share matrix, communication positioning, marketing programs, division list, and key issues; and
an industry overview sub-web, the industry overview sub-web including at least one of the following super-categories: sales trends; growth/share matrix; marketing & advertising trends; media spending; demographics; aftermarket; design & technology; e-commerce; sales issues; safety; mergers, acquisitions and partnerships; environment; and general.

40. The computer system of claim 39 further comprising a downloadable sub-web for at least one of the following sub-webs: industry overview, corporations in the industry, and products produced by the industry.
